(19) United States
(12) Patent Application Publication
(10) Pub. No.: US 2018/0215915 A1
(43) Pub. Date: Aug. 2, 2018

(54) GALVANIZED COMPONENT WITH HIGH HEAT DISTORTION RESISTANCE

(71) Applicant: Covestro Deutschland AG, Leverkusen (DE)

(72) Inventors: Andreas SEIDEL, Dormagen (DE); Wolfgang SCHWARTMANN, Solingen (DE); Eckhard WENZ, Köln (DE); Peter WEIMAR, Leverkusen (DE)

(21) Appl. No.: 15/742,259

(22) PCT Filed: Jul. 4, 2016
(86) PCT No.: PCT/EP2016/065667

§ 371 Date: Jan. 5, 2018

(30) Foreign Application Priority Data
Jul. 6, 2015 (EP) 15175423.1

(51) Int. Cl. C08L 69/00; C23C 18/16; C23C 18/20; C23C 18/24; C23C 18/30; C23C 18/32; C23C 18/38; C25D 5/14; C23F 17/00

(52) U.S. Cl. CPC C08L 69/00; C23C 18/1653; C23C 18/2086; C23C 18/24; C23C 18/30; C08L 2205/025; C23C 18/38; C25D 5/14; C23F 17/00; C08L 2205/03; C23C 18/32

(57) ABSTRACT

The invention relates to a composite component consisting of a plastic support and a multi-ply metal layer applied in a galvanizing operation, the plastic support being made of a thermoplastic composition consisting of A) 50 to 90 parts by weight of at least one aromatic polycarbonate, B) 10 to 50 parts by weight of at least one graft polymer comprising a diene-containing, rubber-elastic, particulate graft base and a vinyl (co)polymer shell, C) 0 to 15 parts by weight of at least one additive, where the sum of the parts by weight of components A) and B) in the composition is standardized to 100, (i) characterized in that the rubber content from component B in the composition is at least 6 wt %, (ii) characterized in that the ratio K/S of the weight fractions of butadiene-containing, rubber-elastic, particulate graft base from component B) in the composition (viz. K) to the sum of free—that is, not bound covalently to the rubber base in the graft polymer of component B)—vinyl (co)polymer from component B) and of any free vinyl (co)polymer from component C) in the composition (viz. S) is at least 1.5, (iii) characterized in that component A) comprises at least one monomer unit selected from the group consisting of monomer units described by the general formula (2) in which R⁴ is H, linear or branched C₁-C₁₀ alkyl, and R⁵ is linear or branched C₁-C₁₀ alkyl, and monomer units derived from bis(4-hydroxyphenyl) compounds and bridged via the 1,1′-position of a cyclic, optionally heteroatom-substituted hydrocarbon, (iv) characterized in that the fraction (A_{cyc}) of monomer units derived from bis(4-hydroxyphenyl) compounds and bridged via the 1,1′-position of a cyclic, optionally heteroatom-substituted hydrocarbon, based on the sum of all bisphenol-derived monomer units in component A), is in the range from 0 to 40 wt %, and, if the fraction of monomer units derived from bis(4-hydroxyphenyl) compounds and bridged via the 1,1′-position of a cyclic, optionally heteroatom-substituted hydrocarbon, based on the sum of all bisphenol-derived monomer units in component A), is in the range <5 wt %, the amount of component A) in the composition is 75 to 87 parts by weight and the amount of component B) in the composition is 13 to 25 parts by weight, and also to the use of the composite component as part of motor vehicles, electrically operated devices, household articles, solar collectors or light reflectors or as a functional element for removing heat. The composite component has high dimensional stability and good metal-to-substrate adhesion even at high service temperatures and under severe temperature fluctuations.

The invention relates to a component part made of a polycarbonate composition as a substrate and a multi-ply metal layer applied thereto by means of a galvanizing process which features high dimensional stability and good adhesion between metal and substrate even at a high use temperature and large temperature variations.

One specific embodiment of the invention relates to a component part made of a polycarbonate composition as the substrate and a multi-ply metal layer applied thereto by means of a galvanizing process, wherein a galvanizing process established for acrylonitrile-butadiene-styrene (ABS) copolymers and blends thereof with polycarbonate is used for producing the component part and the component part features high dimensional stability and good adhesion between metal and substrate even at a high use temperature and large temperature variations.

Galvanizing of ABS and ABS-polycarbonate compositions is known from the literature.

Mariola Brandes, “The new generation of Futuron—A direct metallisation process for plastics with low Pd content” Galvanotecnica e Nuove Finiture (2003), 13(2), 100-102 discloses for example a process for galvanizing ABS and ABS+PC compositions.

Mariola Brandes, “Direct metalizing of ABS and ABS/PC with increased PC content”, Galvanotechnik (2007), 98(4), 872-875 discloses an improved process which for the first time allows metallizing of polycarbonate-ABS molding materials comprising up to 65 wt % of polycarbonate. It was previously only possible to galvanize compositions having a polycarbonate content of not more than 45 wt %.

DE102008047833 (A1) discloses that ABS and ABS/PC are coatable and in particular chromable by means of known methods of plastics galvanizing while polycarbonate by contrast is inert under the conditions of customary plastics galvanizing and does not accept a coating.

WO 2013/115903 A1 discloses galvanizable PC+ABS compositions having an elevated polycarbonate fraction and having improved adhesion of the metal layer to the plastics substrate comprising 40 to 75 wt % of polycarbonate, 24 to 53 wt % of a first impact modifier and 1 to 7 wt % of a second impact modifier.

CN 102146203 A discloses PC+ABS blends having improved galvanizability and good mechanical properties, good heat resistance and good processability in injection molding comprising 20 to 70 wt % of polycarbonate, 20 to 75 wt % of ABS, 2-10 wt % of rubber-rich butadiene-based graft polymer, 0.2 to 0.5 wt % of calcium carbonate, 0 to 1 wt % of antioxidant and 0 to 1 wt % of lubricant.

EP 0 183 167 B1 discloses PC+ABS compositions having excellent heat distortion resistance, toughness and processability in the injection molding process and featuring improved galvanizability which comprise 10 to 90 wt % of aromatic polycarbonate, 10 to 90 wt % of a multi-shell, rubber-based graft polymer and optionally up to 60 wt % of a vinyl copolymer.

However, the ABS or ABS-polycarbonate compositions suitable for galvanizing recited in the prior art have a low heat distortion resistance and galvanized component parts produced therefrom thus have a low maximum use temperature.

Compositions having increased heat distortion resistance compared to polycarbonate molding materials where the polycarbonate is based only on bisphenol A units are likewise known from the literature.

US 2011 0060106 A1 discloses polycarbonate compositions having improved heat resistance, low-temperature toughness and flowability comprising polycarbonate based on n-phenylphenolphthalein (PPPBP) as repeating unit, a second polycarbonate distinct therefrom and an impact modifier.

DE 38 32 396 A1 discloses polycarbonates based on dihydroxydiphenylcycloalkanes having an elevated glass transition temperature.

DE 39 19 043 A1 discloses polycarbonate compositions having improved heat distortion resistance and good toughness comprising polycarbonate based on substituted dihydroxydiphenylcycloalkane, polycarbonate based on for example bisphenol-A and a rubber-modified graft polymer.

DE 39 13 114 A1 discloses polycarbonate compositions having improved heat distortion resistance and good toughness comprising polycarbonate based on substituted dihydroxydiphenylcycloalkane, polycarbonate based on for example bisphenol-A and a silicone-rubber-modified graft polymer.

DE 39 14 946 A1 discloses polycarbonate compositions having high heat distortion resistance and improved notched impact strength and stress cracking resistance under chemicals exposure comprising polycarbonate based on substituted dihydroxyphenylcycloalkane, rubber-based graft polymer and optionally at least one further thermoplastic resin.

EP 0 401 629 A2 discloses polycarbonate compositions having improved heat distortion resistance and good toughness comprising polycarbonate based on substituted dihydroxyphenylcycloalkane, vinyl copolymer and rubber-based graft polymer.

However, the recited applications do not provide any indications whatsoever about the galvanizability of these polycarbonate compositions having high heat distortion resistance and no component parts made of such polycarbonate compositions having high heat distortion resistance and a metal layer applied by galvanizing are known.

Such component parts would be useful for example and would in this regard preferably be employed as (decorative) parts of automobiles (for example for under-hood applications or applications in the exhaust gas region), for use in electrically operated devices (for example for fan heaters, toasters, water heaters/hot water machines, coffee machines, hairdryers, ovens etc.) in household objects subject to high temperatures (for example handles of cooking pots, pressure cookers or grills) or as a part of solar collectors, light reflectors or in functional elements for targeted removal of heat. These exemplary fields of application have in common that the component parts are subject to high temperatures because they are used in spatial proximity to heat sources (for example engines, electrically operated heating apparatuses, hot gas streams, focused incident light) and are thus also intentionally exposed to large temperature variations. Under these extreme conditions of use the galvanized component parts shall remain dimensionally stable and show sufficient adhesion of the metal layer to the plastics substrate and show a stable surface appearance. Temperature changes must in particular not bring about any blister-shaped, let alone large-area, metal detachments.

It was accordingly an object of the present invention to provide galvanized component parts made of a substantially amorphous thermoplastic which on the one hand show adequate adhesion of the multi-ply metal layer applied by the galvanizing process to the plastics carrier and on the other hand show dimensional stability at a temperature of at least 130° C., preferably at a temperature of at least 135° C., particularly preferably of at least 140° C. and under severe temperature variations in the range from room temperature to at least 130° C., preferably to at least 135° C., particularly preferably to at least 140° C., show good and stable adhesion of the substrate and the metal layer.

It is a specific object of the present invention to provide the abovementioned galvanized component parts, wherein a galvanizing process established for acrylonitrile-butadiene-styrene (ABS) copolymers and blends thereof with polycarbonate is used for producing the component parts.

A sufficient adhesion of the multi-ply metal layer to the plastics carrier is generally taken to mean a value of at least 0.20 N/mm measured in the roller peel test according to DIN 53494 (1984 version).

It has now been found that, surprisingly, the object of the invention is achieved by galvanized component parts based on a plastics carrier produced from a thermoplastic composition consisting of

A) 50 to 90 parts by weight, preferably 55 to 88 parts by weight, particularly preferably 60 to 87 parts by weight, of at least one aromatic polycarbonate,
B) 10 to 50 parts by weight, preferably 12 to 45 parts by weight, particularly preferably 13 to 40 parts by weight, of at least one graft polymer comprising a diene-containing elastomeric particulate graft base and a vinyl (co)polymer sheath,
C) 0 to 15 parts by weight, preferably 0.1 to 5 parts by weight, particularly preferably 0.2 to 3 parts by weight, of at least one additive,
wherein the sum of the parts by weight of components A) and B) in the composition is normalized to 100,
(i) characterized in that the rubber content from component B in the composition is at least 6 wt %, preferably at least 7 wt %, particularly preferably at least 9 wt %,
(ii) characterized in that the ratio K/S of the weight fractions of diene-containing elastomeric particulate graft base from component B) in the composition (=K) to the sum of free, i.e. not covalently bonded to the rubber base in the graft polymer according to component B), vinyl (co)polymer from component B) and any free vinyl (co)polymer from component C) in the composition (=S) is at least 1.5, preferably at least 1.8, particularly preferably at least 2.1,
(iii) characterized in that component A) comprises at least one monomer unit selected from the group consisting of monomer units described by general formula (2)

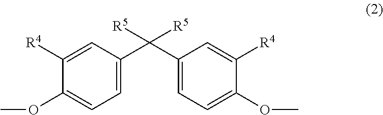

in which
R⁴ represents H, linear or branched C₁-C₁₀ alkyl, preferably linear or branched C₁-C₆ alkyl, particularly preferably linear or branched C₁-C₄ alkyl, very particularly preferably H or C₁-alkyl (methyl), and
R⁵ represents linear or branched C₁-C₁₀ alkyl, preferably linear or branched C₁-C₆ alkyl, particularly preferably linear or branched C₁-C₄ alkyl, very particularly preferably C₁-alkyl (methyl),
and monomer units derived from bis(4-hydroxyphenyl) compounds and bridged via the 1,1′-position of a cyclic hydrocarbon optionally substituted with heteroatoms, preferably monomer units bridged via the 1,1′-position of a cyclic hydrocarbon and described by any of general formulae (1a), (1 b), (1c) and (1d), particularly preferably monomer units bridged via the 1,1′-position of a cyclic hydrocarbon and described by any of the general formulae (1b), (1c) and (1d)

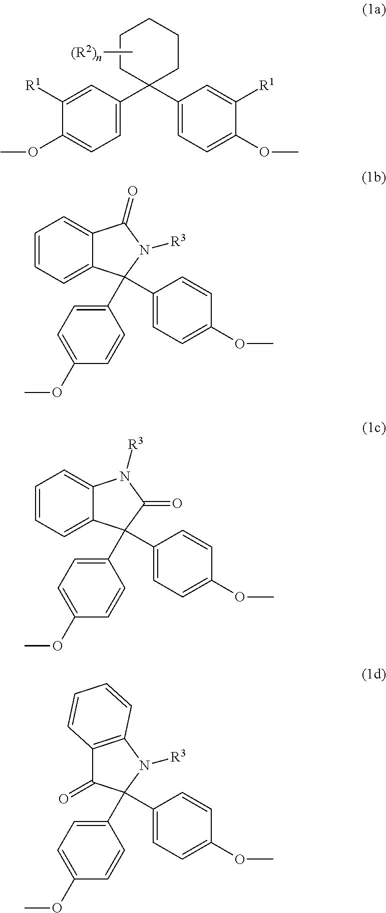

in which
   R¹ represents hydrogen or C₁-C₄-alkyl, preferably hydrogen,
   R² represents C₁-C₄-alkyl, preferably methyl,
   n represents 0, 1, 2 or 3, preferably 3, and
   R³ represents C₁-C₄-alkyl, aralkyl or aryl, preferably methyl or phenyl, very particularly preferably phenyl,
(iv) characterized in that the proportion (A_{cyc}) of monomer units derived from bis(4-hydroxyphenyl) compounds and bridged via the 1,1′-position of a cyclic hydrocarbon optionally substituted with heteroatoms based on the sum of all monomer units derived from bisphenols in component A) is in the range from 0 bis 40 wt %, preferably in the range from 5 to 40 wt %, particularly preferably in the range from 10 to 37 wt %,
wherein in the case where the proportion (A_{cyc}) of monomer units derived from bis(4-hydroxyphenyl) compounds and bridged via the 1,1′-position of a cyclic hydrocarbon optionally substituted with heteroatoms based on the sum of all monomer units derived from bisphenols in component A) is in the range of <5 wt %, the content of component A) in the composition is 75 to 87 parts by weight and the content of component B) in the composition is 13 to 25 parts by weight.

In one specific embodiment the galvanized component parts are based on a plastics carrier produced from a thermoplastic composition consisting of

A) 50 to 90 parts by weight, preferably 55 to 88 parts by weight, particularly preferably 60 to 87 parts by weight, of at least one aromatic polycarbonate,
B) 10 to 50 parts by weight, preferably 12 to 45 parts by weight, particularly preferably 13 to 40 parts by weight, of at least one graft polymer consisting of a diene-containing elastomeric particulate graft base and a vinyl (co)polymer sheath and
C) 0 to 15 parts by weight, preferably 0.1 to 5 parts by weight, particularly preferably 0.2 to 3 parts by weight, of at least one additive,
wherein the sum of the parts by weight of components A) and B) in the composition is normalized to 100,
characterized in that the features described above under (i), (ii) and (iii) apply and
(iv) characterized in that the proportion (A_{cyc}) of monomer units derived from bis(4-hydroxyphenyl) compounds and bridged via the 1,1′-position of a cyclic hydrocarbon optionally substituted with heteroatoms based on the sum of all monomer units derived from bisphenols in component A) is in the range from 5 to 40 wt %, particularly preferably in the range from 10 to 37 wt %.

In a further specific embodiment the galvanized component parts are based on a plastics carrier produced from a thermoplastic composition consisting of

A) 75 to 87 parts by weight of at least one aromatic polycarbonate,
B) 13 to 25 parts by weight of at least one graft polymer comprising a diene-containing elastomeric particulate graft base and a vinyl (co)polymer sheath and
C) 0 to 15 parts by weight, preferably 0.1 to 5 parts by weight, particularly preferably 0.2 to 3 parts by weight, of at least one additive,
wherein the sum of the parts by weight of components A) and B) in the composition is normalized to 100,
characterized in that the features described above under (i), (ii) and (iii) apply and
(iv) characterized in that the proportion (A_{cyc}) of monomer units derived from bis(4-hydroxyphenyl) compounds and bridged via the 1,1′-position of a cyclic hydrocarbon optionally substituted with heteroatoms based on the sum of all monomer units derived from bisphenols in component A) is in the range of <5 wt %.

As the monomer unit in component A) derived from a bis(4-hydroxyphenyl) compound and bridged via the 1,1′-position of a cyclic hydrocarbon optionally substituted with heteroatoms it is preferable to employ at least one representative, particularly preferably precisely one representative, selected from the group consisting of the monomer units derived from 1,1-bis(4-hydroxyphenyl)-3,3,5-trimethylcyclohexane (Bisphenol-TMC) and 2-phenyl-3,3-bis(4-hydroxyphenyl)phthalimide (PPPBP).

Having regard to the processing properties in injection molding and the properties of the galvanized component parts produced from the compositions and thus having regard to the use of the compositions and molding materials for producing galvanized moldings, compositions employing the monomer unit derived from 2-phenyl-3,3′-bis(4-hydroxyphenyl)phthalimide (PPPBP) as the monomer unit in component A) derived from a bis(4-hydroxyphenyl) compound and bridged via the 1,1′-position of a cyclic hydrocarbon optionally substituted with heteroatoms have proven particularly advantageous and thus preferred as a substrate for producing galvanized component parts having high distortion resistance and metal adhesion at high and severely varying temperatures.

In a preferred embodiment component A) has a relative solution viscosity of 1.20 to 1.28 determined according to DIN 51562 in methylene chloride (1999 version).

In terms of the rubber content from component B in the composition the upper limit Kₘₐₓ is specified merely by the proportion of component B and the rubber fraction B.2 in component B via the formula Kₘₐₓ=B·B.2.

In terms of the ratio K/S there is no upper limit since it is in principle advantageous to minimize the proportion of S. In a preferred embodiment component C therefore comprises no free (i.e. not chemically bonded to the rubber base) vinyl (co)polymer. Also preferable therefore is the use of a component B having a highest possible gel content of at least 70 wt %, particularly preferably at least 75 wt %, very particularly preferably at least 80 wt %.

In preferred embodiments the employed rubber-containing graft polymer according to component B) is a graft polymer based on a diene-containing elastomeric particulate graft base, characterized in that the proportion of the rubber particles in the graft base having a diameter of <200 nm is at least 10 wt %, preferably at least 20 wt %.

In a further preferred embodiment the content of free vinyl (co)polymer in the composition (sum from component B and component C) is less than 7 wt %, particularly preferably less than 6 wt %, in particular less than 5 wt %.

A further aspect of the present invention is the use of the above-described molding materials for producing galvanized component parts which show dimensional stability at a temperature of at least 130° C., preferably at a temperature of at least 135° C., particularly preferably at a temperature of at least 140° C. and under severe temperature variations in the range from room temperature to at least 130° C., preferably from room temperature to at least 135° C., particularly preferably from room temperature to at least 140° C., show good and stable adhesion of the substrate and the metal layer.

The present invention therefore also relates to a process for producing galvanized component parts which show dimensional stability at a temperature of at least 130° C., preferably at a temperature of at least 135° C., particularly preferably at a temperature of at least 140° C. and under severe temperature variations in the range from room temperature to at least 130° C., preferably from room temperature to at least 135° C., particularly preferably from room temperature to at least 140° C., show good and stable adhesion of the substrate and the metal layer.

This process is characterized in that
(i) in a first step a plastics carrier made of a thermoplastic composition as described above is formed, wherein preferably an extrusion, blow molding, thermoforming or injection molding process, particularly preferably an injection molding process, is used for forming in the production of this carrier,
(ii) and in a second process step this plastics carrier is galvanized in a galvanizing process established for acrylonitrile-butadiene-styrene (ABS) copolymers and blends thereof with polycarbonate.

As preferred embodiments of this production process the same preferred ranges relating to the thermoplastic compositions as previously described for the component part apply in process step (i).

The process parameters in process step (i) are preferably to be chosen such that the carrier component part employed in the galvanizing process according to the process step (ii) is as unstressed as possible. To this end when using injection molding processes for forming it is advantageous to choose the lowest possible injection rate, injection pressure and holding pressure and the highest possible mold temperature. The specific conditions result from the mold geometry and the mold sprue. Specific injection pressures of not more than 600 bar are advantageous. The specific holding pressure preferably commences at the value of the specific injection pressure and is then preferably reduced gradually.

The mold temperature is preferably in the range 80° C. to 140° C., particularly preferably in the range 100 to 130° C.

In process step (i) it also proves particularly advantageous and therefore preferable when a variothermal injection molding process is employed in which the injection mold is initially heated to a temperature above the glass transition temperature of the polycarbonate component A), preferably of at least 150° C., particularly preferably of at least 160° C., after injection of the polycarbonate composition into the mold this temperature is maintained for the duration of the holding pressure time and only afterwards the mold is cooled to a temperature below the glass transition temperature of the polycarbonate component A), preferably in the range 80° C. to 140° C., particularly preferably in the range 100 to 130° C., thereby consolidated and finally demolded. Such processes make it possible to realize a further improvement in the practical heat distortion resistance of the galvanized component parts compared to standard injection molding processes.

The plastics carrier produced in process step (i) may in principle be a sheet or a three-dimensional component part of any desired shape.

The plastics carrier has a wall thickness of 0.2 to 10 mm, preferably 1 to 4 mm, particularly preferably 2 to 3 mm.

After production in process step (i) the plastics carrier is preferably intermediately stored until post-shrinkage has ended. This typically requires 10 to 48 h. This intermediate storage further reduces any stresses still present in the plastics part.

Process step (ii) of galvanizing comprises the following individual steps:

(ii-1) pickling of the plastics carrier produced in process step (i), for example and preferably with chromosulfuric acid, wherein in preferred embodiments in this process step a wetting aid (for example Udique® Wetting Agent BL2030 from Entone) is employed as a process auxiliary which reduces the surface tension between the plastics carrier and the pickling agent, followed by a chemical reduction of the chromosulfuric acid using a reducing agent such as for example iron II chloride and subsequent thorough rinsing with water for effective removal of chromium residues,
(ii-2) activation of the thus pretreated plastics carrier by adsorption of a palladium colloid, preferably a palladium colloid having a tin chloride sheath, onto the carrier surface,
(ii-3) generation of palladium seeds for later deposition of chemical nickel or chemical copper on the plastics carrier surface by destruction of the sheath of the adsorbed palladium colloid by treatment with a diluted Brønsted acid,
(ii-4) deposition of chemical nickel or chemical copper on the thus pretreated plastics carrier from a nickel (II) or a copper (II) salt solution using a chemical reducing agent, for example a dihydrogenphosphite salt,
(ii-5) electrochemical application of a copper metal layer,
(ii-6) electrochemical application of a nickel metal layer and
(ii-7) electrochemical application of a further metal layer having a high resistance to environmental influences, for example and preferably a chromium metal layer.

In a preferred embodiment of the galvanizing process (ii) before process step (ii-2) the plastics carrier from process step (ii-1) is immersed in the aqueous solution of a Brønsted acid, preferably in a k hydrochloric acid solution.

In a further preferred embodiment of the galvanizing process (ii) before process step (ii-2) the plastics carrier from process step (ii-1) is treated with a so-called “conditioner” which as a processing aid improves the adsorption of the palladium colloid in process step (ii-2). These are substances preferably selected from the group of the amines, preferably cyclohexanediamine. The “conditioner” is preferably employed as an aqueous solution. Before or after treatment with the “conditioner” an additional treatment of the plastics carrier with an aqueous solution of a Brønsted acid, preferably a hydrochloric acid solution, may optionally be effected.

The extent of palladium adsorption is determined inter alia by the nature of the palladium colloid and the conditions in activation step (ii-2), in particular activation duration, temperature and employed concentration of the palladium colloid.

The conditions in activation step (ii-2) and in any upstream conditioning steps as described above are preferably chosen such that a coverage of the plastics carrier surface of at least 4 mg palladium/m², preferably of at least 5 mg palladium/m², results after process step (ii-3). The palladium coverage deposited after process step (ii-3) is preferably not more than 50 mg palladium/m², particularly preferably not more than 30 mg palladium/m².

In process step (ii-4) an uninterrupted chemical nickel or chemical copper layer, preferably having a thickness of 500 nm to 5 μm, particularly preferably of 1 μm to 2 μm, is applied.

In a preferred embodiment of the galvanizing process (ii) in process step (ii-5) initially in a first step

(ii-5.1) a thin reinforcing layer made of nickel or copper is electrochemically applied and then in a second step
(ii-5.2) a thicker high-gloss layer made of copper metal is electrochemically applied, wherein a higher current density is employed in process step (ii-5.2) than in process step (ii-5.1). In a particularly preferred embodiment the current density in process step (ii-5.2) is at least 30%, particularly preferably at least 50%, higher than the current density in process step (ii-5.1). This preferred embodiment makes it possible to reduce the time necessary for applying the high-gloss copper metal layer.

By choosing the process parameters in step (ii-6) the surface appearance of the component parts according to the invention in terms of gloss may be varied from high-gloss to matt.

It is preferable when the component parts according to the invention are high-gloss, i.e. they have a gloss of greater than 90, preferably greater than 95, particularly preferably greater than 98 at a viewing angle of 60°. Gloss in the context of the present invention is to be understood as meaning the value determined according to ISO 2813-2015 version.

The component parts according to the invention consist of a plastics carrier produced from a thermoplastic composition as described above and a multi-ply metal layer adherent thereto consisting of at least three, preferably at least four, metal plies distinguishable by microscopy and/or chemical analysis.

The thickness of the multi-ply metal layer is 5 to 200 μm, preferably 10 to 60 μm, particularly preferably 30 to 50 μm.

In a first embodiment the multi-ply metal layer consists of three metal plies distinguishable by microscopy and chemical analysis, namely, starting from the plastics carrier,
(i) of a first ply made of copper,
(ii) a second ply made of nickel,
(iii) and a third ply made of a metal having a high resistance to environmental influences, for example and preferably made of chromium.

In a second, preferred embodiment the multi-ply metal layer consists of four metal plies distinguishable by microscopy and chemical analysis, namely, starting from the plastics carrier,
(i) of a first ply made of nickel,
(ii) a second ply made of copper,
(iii) a third ply made of nickel,
(iv) and a fourth ply made of a metal having a high resistance to environmental influences, for example and preferably made of chromium.

The necessary thicknesses of the individual metal plies and thus the thickness of the entire metal layer in the composite component part result from the demands on mechanical properties, resistance toward environmental influences, heat distortion resistance and further necessary properties of the component part.

The copper metal ply preferably has a thickness of 10 to 50 μm, particularly preferably of 15 to 30 μm, very particularly preferably of 20 to 30 μm.

In preferred embodiments the nickel metal layer which starting from the plastics carrier follows the copper layer has a thickness of not more than half of that of the copper metal layer therebelow.

The uppermost metal ply made of a metal having a high resistance to environmental influences, preferably made of chromium, preferably has a thickness of 100 nm to 3 μm, particularly preferably of 200 nm to 1.5 μm.

For component parts in which the plastics carrier is directly adjacent to a nickel metal layer, said nickel metal layer usually and preferably has a thickness of 500 nm to 5 μm, particularly preferably of 1 μm to 2 μm.

Preferred embodiments 1 to 25 of the present invention are described below:

1.) Composite component part consisting of a plastics carrier and a multi-ply metal layer applied via a galvanizing process, wherein the plastics carrier is produced from a thermoplastic composition consisting of

A) 50 to 90 parts by weight of at least one aromatic polycarbonate,
B) 10 to 50 parts by weight of at least one graft polymer comprising a diene-containing elastomeric particulate graft base and a vinyl (co)polymer sheath,
C) 0 to 15 parts by weight of at least one additive,
wherein the sum of the parts by weight of components A) and B) in the composition is normalized to 100,
(i) characterized in that the rubber content from component B in the composition is at least 6 wt %,
(ii) characterized in that the ratio K/S of the weight fractions of butadiene-containing elastomeric particulate graft base from component B) in the composition (=K) to the sum of free, i.e. not covalently bonded to the rubber base in the graft polymer according to component B), vinyl (co)polymer from component B) and any free vinyl (co)polymer from component C) in the composition (=S) is at least 1.5,
(iii) characterized in that component A) comprises at least one monomer unit selected from the group consisting of monomer units described by general formula (2)

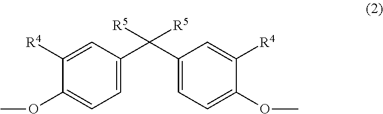

in which
R⁴ represents H, linear or branched C₁-C₁₀ alkyl and
R⁵ represents linear or branched C₁-C₁₀ alkyl,
and monomer units derived from bis(4-hydroxyphenyl) compounds and bridged via the 1,1′-position of a cyclic hydrocarbon optionally substituted with heteroatoms,
(iv) characterized in that the proportion (A_{cyc}) of monomer units derived from bis(4-hydroxyphenyl) compounds and bridged via the 1,1′-position of a cyclic hydrocarbon optionally substituted with heteroatoms based on the sum of all monomer units derived from bisphenols in component A) is in the range from 0 to 40 wt %,
wherein in the case where the proportion (A_{cyc}) of monomer units derived from bis(4-hydroxyphenyl) compounds and bridged via the 1,1′-position of a cyclic hydrocarbon optionally substituted with heteroatoms based on the sum of all monomer units derived from bisphenols in component A) is in the range of <5 wt %, the content of component A) in the composition is 75 to 87 parts by weight and the content of component B) in the composition is 13 to 25 parts by weight.

2.) Composite component part according to embodiment 1 consisting of a plastics carrier and a metal layer applied via a galvanizing process, wherein the plastics carrier is produced from a thermoplastic composition consisting of

A) 60 to 87 parts by weight of at least one aromatic polycarbonate,
B) 13 to 40 parts by weight of at least one graft polymer comprising a diene-containing elastomeric particulate graft base and a vinyl (co)polymer sheath,
C) 0.2 to 3 parts by weight of at least one additive,
wherein the sum of the parts by weight of components A) and B) in the composition is normalized to 100.

3.) Composite component part according to embodiment 1 or 2, characterized in that as component C one or more additives selected from the group consisting of flame retardants, anti-drip agents, flame retardant synergists, smoke inhibitors, lubricants and demolding agents, nucleating agents, antistats, conductivity additives, stabilizers, flow promoters, compatibilizers, further impact modifiers distinct from component B, further polymeric constituents, fillers and reinforcers and also dyes and pigments are employed.

4.) Composite component part according to any of the preceding embodiments, characterized in that the rubber content from component B in the composition is at least 9 wt %.

5.) Composite component part according to any of the preceding embodiments, characterized in that the ratio K/S is at least 2.1.

6.) Composite component part according to any of the preceding embodiments, characterized in that A_{cyc} is between 10 and 37 wt %.

7.) Composite component part according to any of the preceding embodiments, characterized in that the monomer units derived from bis(4-hydroxyphenyl) compounds and bridged via the 1,1′-position of a cyclic hydrocarbon optionally substituted with heteroatoms are selected from the structures described by the formulae

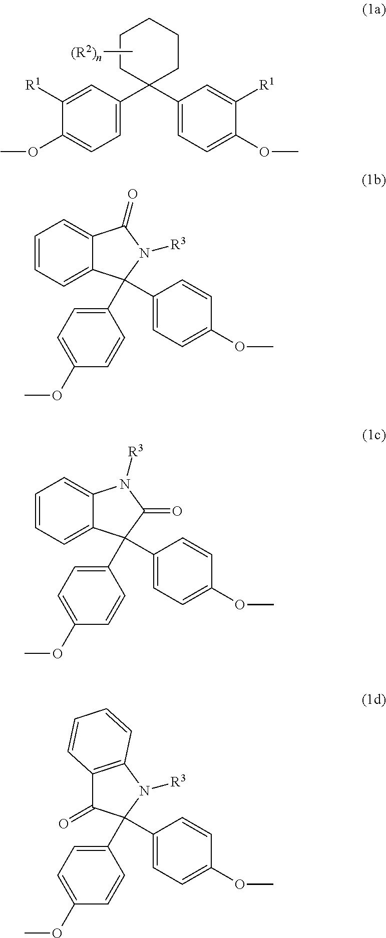

in which
   R¹ represents hydrogen or C₁-C₄-alkyl,
   R² represents C₁-C₄-alkyl,
   n represents 0, 1, 2 or 3 and
   R³ represents C₁-C₄-alkyl, aralkyl or aryl.

8.) Composite component part according to embodiment 7, characterized in that the monomer units derived from bis(4-hydroxyphenyl) compounds and bridged via the 1,1′-position of a cyclic hydrocarbon optionally substituted with heteroatoms are selected from the structures described by the formulae (1b), (1c) and (1d).

9.) Composite component part according to embodiment 8, characterized in that in formulae (1b), (1c) and (1d) R³ represents methyl or phenyl.

10.) Composite component part according to embodiment 7, characterized in that the monomer unit derived from bis(4-hydroxyphenyl) compounds and bridged via the 1,1′-position of a cyclic hydrocarbon optionally substituted with heteroatoms is derived from 2-phenyl-3,3′-bis(4-hydroxyphenyl)phthalimide.

11.) Composite component part according to any of the preceding embodiments, characterized in that the relative solution viscosity of component A measured in methylene chloride according to DIN 51562-1999 version is in the range from 1.20 to 1.28.

12.) Composite component part according to embodiment 11, characterized in that upon use of copolycarbonates based on at least one monomer unit selected from the group characterized by general formula (1a) and at least one monomer unit selected from the group characterized by general formula (2) the relative solution viscosity of this copolymer employed in component A is in the range from 1.23-1.27.

13.) Composite component part according to embodiment 11, characterized in that upon use of copolycarbonates based on at least one monomer unit selected from any of groups (1b), (1c) and (1d) and at least one monomer unit selected from the group characterized by general formula (2) the relative solution viscosity of this copolymer employed in component A is in the range from 1.20-1.24.

14.) Composite component part according to embodiment 11, characterized in that upon use of homo- or copolycarbonates based on at least one monomer unit selected from the group characterized by general formula (2) which comprise no monomer units derived from bis(4-hydroxyphenyl) compounds and bridged via the 1,1′-position of a cyclic hydrocarbon optionally substituted with heteroatoms the relative solution viscosity of this homo- or copolymer employed in component A is in the range from 1.23-1.27.

15.) Composite component part according to any of the preceding embodiments, characterized in that the proportion of rubber particles in the graft base B.2 having a diameter of <200 nm is at least 20 wt %.

16.) Composite component part according to any of the preceding embodiments, characterized in that the metal layer surface has a gloss measured according to ISO 2813-2015 version at a viewing angle of 60° of greater than 90.

17.) Composite component part according to any of the preceding embodiments, characterized in that the composite component part shows dimensional stability at a temperature of at least 130° C., and under severe temperature variations in the range from room temperature to at least 130° C. shows good and stable adhesion of the substrate and the metal layer.

18.) Composite component part according to embodiment 17, characterized in that the adhesion of the multi-ply metal layer to the plastics carrier has a value of at least 0.20 N/mm measured in the roller peel test according to DIN 53494-1989 version.

19.) Composite component part according to any of the preceding embodiments, characterized in that the multi-ply metal layer consists of at least 3 metal plies distinguishable by microscopy and/or chemical analysis.

20.) Composite component part according to any of the preceding embodiments, characterized in that the multi-ply metal layer is constructed, starting from the plastics carrier,

from a first ply made of copper, a second ply made of nickel and a third ply made of chromium or
from a first ply made of nickel, a second ply made of copper, a third ply made of nickel and a fourth ply made of chromium.

21.) Composite part according to embodiment 20, characterized in that the nickel metal layer which starting from the plastics carrier follows the copper metal layer has a thickness of not more than half of that of the copper metal layer therebelow.

22.) Composite component part according to any of the preceding embodiments, characterized in that the multi-ply metal layer has a thickness of 30 to 50 μm.

23.) Composite component part according to any of the preceding embodiments, characterized in that the copper metal ply has a thickness of 15 to 30 μm.

24.) Composite component part according to any of the preceding embodiments, characterized in that the chromium metal ply has a thickness of 200 nm to 1.5 μm.

25.) Use of the composite component part according to any of embodiments 1 to 24 as a part of automobiles, electrically operated devices, household objects, solar collectors, light reflectors or as a functional element for the removal of heat.

26.) Use of the composite component part according to embodiment 25, characterized in that the composite component parts are used in spatial proximity to a heat source selected from the group consisting of engines, electrically operated heating apparatuses, hot gas streams and focused incident light.

### Definitions

C₁-C₄-alkyl in the context of the invention represents for example methyl, ethyl, n-propyl, iso-propyl, n-butyl, sec.-butyl, tert.-butyl, C₁-C₆-alkyl moreover represents for example n-pentyl, 1-methylbutyl, 2-methylbutyl, 3-methylbutyl, neo-pentyl, 1-ethylpropyl, cyclohexyl, cyclopentyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl or 1-ethyl-2-methylpropyl, C₁-C₁₀-alkyl moreover represents for example n-heptyl and n-octyl, pinacyl, adamantyl, the isomeric menthyls, n-nonyl, n-decyl, C₁-C₃₄-alkyl moreover represents for example n-dodecyl, n-tridecyl, n-tetradecyl, n-hexadecyl or n-octadecyl. The same applies for the corresponding alkyl radical for example in aralkyl/alkylaryl, alkylphenyl or alkylcarbonyl radicals. Alkylene radicals in the corresponding hydroxyalkyl or aralkyl/alkylaryl radicals represent for example the alkylene radicals corresponding to the preceding alkyl radicals.

Aryl is a carbocyclic aromatic radical having 6 to 34 skeletal carbon atoms. The same applies for the aromatic part of an arylalkyl radical, also known as an aralkyl radical, and for aryl constituents of more complex groups, for example arylcarbonyl radicals.

Examples of C₆-C₃₄-aryl are phenyl, o-, p-, m-tolyl, naphthyl, phenanthrenyl, anthracenyl and fluorenyl.

### Component A

The composition according to the invention comprises as component A at least one component selected from the group consisting of homo- or copolycarbonates comprising one or more monomer units of general formula (2) and homo- and copolycarbonates comprising one or more monomer units derived from bis(4-hydroxyphenyl) compounds and bridged via the 1,1′-position of a cyclic hydrocarbon optionally substituted with heteroatoms, preferably monomer units bridged via the 1,1′-position of a cyclic hydrocarbon optionally substituted with heteroatoms of general formulae (1a), (1b), (1c) and (1d) and optionally monomer units of general formula (2).

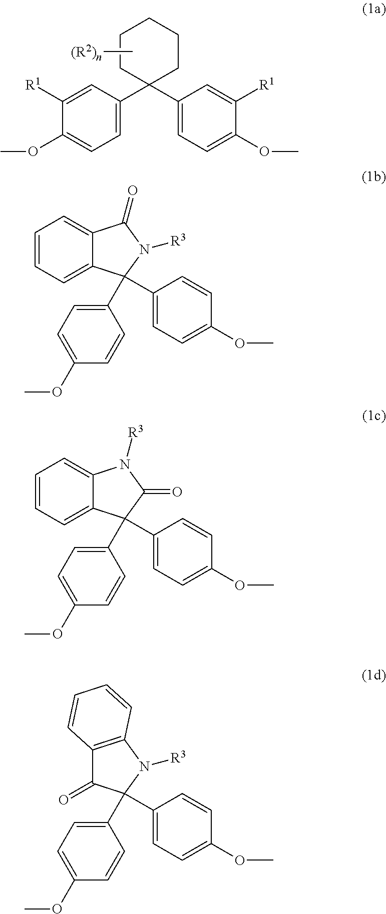

in which
   R¹ represents hydrogen or C₁-C₄-alkyl, preferably hydrogen,
   R² represents C₁-C₄-alkyl, preferably methyl,
   n represents 0, 1, 2 or 3, preferably 3, and
   R³ represents C₁-C₄-alkyl, aralkyl or aryl, preferably methyl or phenyl, very particularly preferably phenyl.

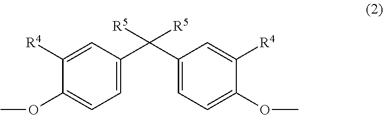

in which
   R⁴ represents H, linear or branched C₁-C₁₀ alkyl, preferably linear or branched C₁-C₆ alkyl, particularly preferably linear or branched C₁-C₄ alkyl, very particularly preferably H or C₁-alkyl (methyl), and
   R⁵ represents linear or branched C₁-C₁₀ alkyl, preferably linear or branched C₁-C₆ alkyl, particularly preferably linear or branched C₁-C₄ alkyl, very particularly preferably C₁-alkyl (methyl).

It is also possible to employ mixtures of different homo- and/or copolycarbonates from the abovementioned group as component A.

The monomer unit(s) of general formula (1a) is/are introduced via one or more corresponding diphenols of general formula (1a′):

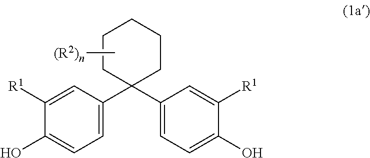

in which
R¹ represents hydrogen or C₁-C₄-alkyl, preferably hydrogen,
R² represents C₁-C₄-alkyl, preferably methyl, and
n represents 0, 1, 2 or 3, preferably 3.

The diphenols of formulae (1a′) to be employed in accordance with the invention and the employment thereof in homopolycarbonates are disclosed in DE 3918406 for example.

Particular preference is given to 1,1-bis(4-hydroxyphenyl)-3,3,5-trimethylcyclohexane (Bisphenol TMC) having the formula (1a″):

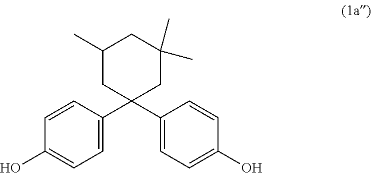 [SMILES: CC1CC(C)(C)CC(c2ccc(O)cc2)(c2ccc(O)cc2)C1]

The monomer unit(s) of general formula (1b), (1c) and (1d) are introduced via one or more corresponding diphenols of general formulae (1b′), (1c′) and (1d′):

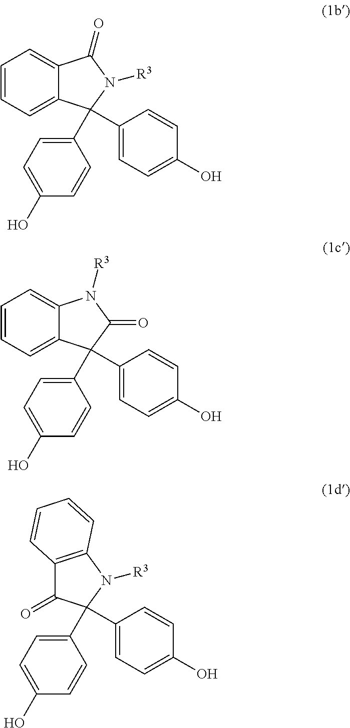

in which R³ represents C₁-C₄-alkyl, aralkyl or aryl, preferably methyl or phenyl, very particularly preferably phenyl.

The monomer unit(s) of general formula (2) is/are introduced via one or more corresponding diphenols of general formula (2a):

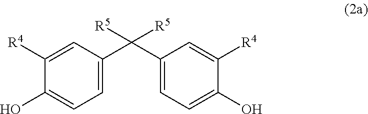

in which R⁴ represents H, linear or branched C₁-C₁₀-alkyl, preferably linear or branched C₁-C₆-alkyl, particularly preferably linear or branched C₁-C₄-alkyl, very particularly preferably H or C₁-alkyl (methyl) and
in which R⁵ represents linear or branched C₁-C₁₀-alkyl, preferably linear or branched C₁-C₆-alkyl, particularly preferably linear or branched C₁-C₄-alkyl, very particularly preferably C₁-alkyl (methyl).

Diphenol (2b) in particular is very particularly preferred here.

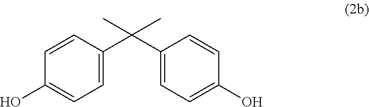 [SMILES: CC(C)(c1ccc(O)cc1)c1ccc(O)cc1]

In addition to one or more monomer units of formulae (1a), (1b), (1c), (1d) and (2) the polycarbonates of component A may also comprise one or more monomer unit(s) of formula (3) which are distinct from the monomer units according to formulae (1a), (1b), (1c), (1d) and (2):

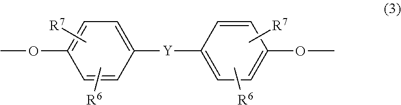

in which
R⁶ and R⁷ independently of one another represent H, C₁-C₁₈-alkyl-, C₁-C₁₈-alkoxy, halogen such as Cl or Br or respectively optionally substituted aryl or aralkyl, preferably H or C₁-C₁₂-alkyl, particularly preferably H or C₁-C₈-alkyl and very particularly preferably H or methyl, and
Y represents a single bond, —SO₂—, —CO—, —O—, —S—, C₁-C₆-alkylene or C₂-C₅-alkylidene, furthermore C₆-C₁₂-arylene, which may optionally be fused with further heteroatom-comprising aromatic rings.

The monomer unit(s) of general formula (3) is/are introduced via one or more corresponding diphenols of general formula (3a):

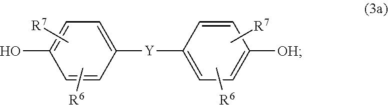

wherein R⁶, R⁷ and Y are each as defined above in connection with formula (3).

Examples of the diphenols of formula (3a) which may be employed in addition to the diphenols of formulae (1a′), (1b′), (1c′), (1d′) and (2) include hydroquinone, resorcinol, dihydroxybiphenyls, bis(hydroxyphenyl)alkanes distinct from formula (2a), bis(hydroxyphenyl)sulfides, bis(hydroxyphenyl) ethers, bis(hydroxyphenyl)ketones, bis(hydroxyphenyl)sulfones, bis(hydroxyphenyl)sulfoxides, α,α′-bis(hydroxyphenyl)diisopropylbenzenes and the ring-alkylated and ring-halogenated compounds thereof and also α,ω-bis(hydroxyphenyl)polysiloxanes.

The diphenols used for producing the polycarbonates according to component A are known from the literature and producible by methods known from the literature (see for example H. J. Buysch et al., Ullmann's Encyclopedia of Industrial Chemistry, VCH, New York 1991, 5th Ed., Vol. 19, p. 348).

The copolycarbonate components in component A may be present as block copolycarbonate and random copolycarbonate. Random copolycarbonates are particularly preferred.

Preferred methods of production of the homo- or copolycarbonates (also referred to hereinbelow as (co)polycarbonates) preferably employed in the composition according to the invention as component A are the interfacial method and the melt transesterification process.

To obtain high molecular weight (co)polycarbonates by the interfacial method the alkali salts of diphenols are reacted with phosgene in a biphasic mixture. The molecular weight may be controlled by the amount of monophenols which act as chain terminators, for example phenol, tert-butylphenol or cumylphenol, particularly preferably phenol, tert-butylphenol. These reactions form practically exclusively linear polymers. This may be confirmed by end-group analysis. Through deliberate use of so-called branching agents, generally polyhydroxylated compounds, branched polycarbonates are also obtained.

To obtain high molecular weight (co)polycarbonates by the melt transesterification process, diphenols are reacted in the melt with carbonic diesters, normally diphenyl carbonate, in the presence of catalysts, such as alkali metal salts, ammonium or phosphonium compounds.

The melt transesterification process is described for example in Encyclopedia of Polymer Science, Vol. 10 (1969), Chemistry and Physics of Polycarbonates, Polymer Reviews, H. Schnell, Vol. 9, John Wiley and Sons, Inc. (1964) and in DE-C 10 31 512.

Relative solution viscosity in the context of the present application is determined in methylene chloride according to DIN 51652-1999 version. The relative solution viscosity of component A employed in the composition according to the invention is preferably in the range of =1.20-1.28. If a mixture of different (co)polycarbonates is employed as component A the relative solution viscosity of this mixture employed as component A is preferably in this range of 1.20-1.28.

Upon use of copolycarbonates based on at least one monomer unit selected from the group characterized by general formula (1a) and at least one monomer unit selected from the group characterized by general formula (2) the relative solution viscosity of this copolymer employed in component A is preferably in the range from 1.23-1.27.

Upon use of copolycarbonates based on at least one monomer unit selected from any of groups (1b), (1c) and (1d) and at least one monomer unit selected from the group characterized by general formula (2) the relative solution viscosity of this copolymer employed in component A is preferably in the range from 1.20-1.24.

Upon use of homo- or copolycarbonates based on at least one monomer unit selected from the group characterized by general formula (2) which comprise no monomer units derived from bis(4-hydroxyphenyl) compounds and bridged via the 1,1′-position of a cyclic hydrocarbon optionally substituted with heteroatoms the relative solution viscosity of this homo- or copolymer employed in component A is preferably in the range from 1.20-1.28, very particularly preferably in the range from 1.23-1.27.

### Component B

Component B comprises one or more graft polymers of
B.1 10 to 70 wt %, preferably 15 to 60 wt %, particularly preferably 20 to 55 wt %, of at least one vinyl monomer
B.2 30 to 90 wt %, preferably 40 to 85 wt %, particularly preferably 45 to 80 wt %, of at least one elastomeric particulate graft base selected from the group consisting of diene rubbers and EPDM rubbers (i.e. based on ethylene/propylene and diene),

The graft base B.2 generally has a median particle size (d₅₀ value) of 0.05 to 1 μm, preferably 0.1 to 0.7 μm, particularly preferably 0.2 to 0.5 μm.

In preferred embodiments the proportion of rubber particles in the graft base B.2 having a diameter of <200 nm is at least 10 wt %, preferably at least 20 wt %.

Monomers B.1 are preferably mixtures of
B.1.1 50 to 99 wt %, preferably 65 to 85 wt %, preferably 70 to 80 wt %, in each case based on the sum of the monomers of the graft sheath B.1, of vinylaromatics and/or ring-substituted vinylaromatics (such as styrene, α-methylstyrene, p-methylstyrene, p-chlorostyrene) and/or (C₁-C₈-alkyl (meth)acrylates, such as methyl methacrylate, ethyl methacrylate and butyl acrylate, and
B.1.2 1 to 50 wt %, preferably 15 to 35 wt %, particularly preferably 20 to 30 wt %, in each case based on the sum of the monomers of the graft sheath 3.1, of vinyl cyanides (unsaturated nitriles such as acrylonitrile and methacrylonitrile) and/or (C₁-C₈-alkyl (meth)acrylates, for example methyl methacrylate, n-butyl acrylate, t-butyl acrylate, and/or derivates (such as anhydrides and imides) of unsaturated carboxylic acids, for example maleic anhydride and N-phenylmaleimide.

Preferred monomers B.1.1 are selected from at least one of the monomers styrene, α-methylstyrene and methyl methacrylate. Preferred monomers B.1.2 are selected from at least one of the monomers acrylonitrile, maleic anhydride and methyl methacrylate. Particularly preferred monomers are B.1.1 styrene and B.1.2 acrylonitrile.

Preferred graft bases B.2 are diene rubbers (for example based on butadiene and/or isoprene) or mixtures of diene rubbers. Diene rubbers in the context of the invention are to be understood as also encompassing diene-monomer-containing copolymers comprising copolymerizable monomers (for example according to B.1.1 and B.1.2) These may be both random copolymers and copolymers having a block structure.

The graft bases B.2 preferably have a glass transition temperature of <−30° C., particularly preferably <−50° C., very particularly preferably <−70° C.

Particularly preferred polymers B are for example ABS polymers, in particular those produced in the emulsion polymerization process as described for example in Ullmanns, Enzyklopädie der Technischen Chemie, vol. 19 (1980), p. 280 et seq.

Since, as is well known, the graft monomers are not necessarily entirely grafted onto the graft base in the grafting reaction, according to the invention graft polymers B are to be understood as also encompassing products generated by (co)polymerization of the graft monomers B.1 in the presence of the graft base B.2 and coobtained in the workup. These products may thus also comprise free, i.e. not covalently bonded to the graft base B.2, vinyl (co)polymer from B.1.1 and B.1.2.

The gel content of the graft polymers B, measured in acetone as solvent, is preferably at least 70 wt %, particularly preferably at least 75 wt %, very particularly preferably at least 80 wt %. Thus the proportion y calculated according to y=100%−gel content is a measure of the free, i.e. not covalently bonded to the graft base, vinyl (co)polymer from B.1.1 and B.1.2

It is preferable when the graft polymer of components B.1 and B.2 has a core-shell structure, wherein component B.1 forms the shell (also described as sheath) and component B.2 forms the core; (see by way of example Ullmann's Encyclopedia of Industrial Chemistry, VCH-Verlag, Vol. A21, 1992, p. 635 and p. 656).

The graft copolymers B are produced by free radical polymerization.

The gel content of the graft polymers B is determined at 25° C. in a suitable solvent, preferably in acetone (M. Hoffmann, H. Krömer, R. Kuhn, Polymeranalytik I and II, Georg Thieme-Verlag, Stuttgart 1977).

The median particle size d₅₀ is the diameter with 50 wt % of the particles above it and 50 wt % below it. It is determined by ultracentrifuge measurement (W. Scholtan, H. Lange, Kolloid, Z. and Z. Polymere 250 (1972), 782-796). This method is used in the context of the present application to determine the rubber particle size distribution. The proportion of rubber particles in the graft base B.2 having a diameter of <200 nm may also be determined therefrom.

Glass transition temperature in the context of the present application is determined by differential scanning calorimetry (DSC) in accordance with the standard DIN EN 61006 (2004 version) at a heating rate of 10 K/min where T_{g} is defined as the midpoint temperature (tangent method).

### Component C

The composition may comprise as component C one or more further additives preferably selected from the group consisting of flame retardants (for example organic phosphorus or halogen compounds, in particular bisphenol-A-based oligophosphate), anti-drip agents (for example compounds from the classes of fluorinated polyolefins, silicones, and also aramid fibers), flame retardant synergists (for example nanoscale metal oxides), smoke inhibitors (for example zinc borate), lubricants and demolding agents (for example pentaerythritol tetrastearate), nucleating agents, antistats, conductivity additives, stabilizers (e.g. hydrolysis, heat-ageing and UV stabilizers, and also transesterification inhibitors and acid/base quenchers), flow promoters, compatibilizers, further impact modifiers distinct from component B (with or without core-shell structure), further polymeric constituents (for example functional blend partners), fillers and reinforcers (for example carbon fibers, talc, mica, kaolin, CaCO₃) and also dyes and pigments (for example titanium dioxide or iron oxide).

In preferred embodiments the composition is free from flame retardants, anti-drip agents, flame retardant synergists and smoke inhibitors.

In likewise preferred embodiments the composition is free from fillers and reinforcers.

In particularly preferred embodiments the composition is free from flame retardants, anti-drip agents, flame retardant synergists, smoke inhibitors and fillers and reinforcers.

In preferred embodiments the composition comprises at least one polymer additive selected from the group consisting of lubricants and demolding agents, stabilizers, flow promoters, compatibilizers, further impact modifiers distinct from component B, further polymeric constituents, dyes and pigments.

In preferred embodiments component C comprises no free (i.e. not chemically bonded to the rubber base) vinyl (co)polymer.

In particularly preferred embodiments the composition comprises at least one polymer additive selected from the group consisting of lubricants and demolding agents, stabilizers, flow promoters, compatibilizers, further impact modifiers distinct from component B, further polymeric constituents, dyes and pigments and is free from further polymer additives.

In preferred embodiments the composition comprises at least one polymer additive selected from the group consisting of lubricants/demolding agents and stabilizers.

In particularly preferred embodiments the composition comprises at least one polymer additive selected from the group consisting of lubricants/demolding agents and stabilizers and is free from further polymer additives.

In preferred embodiments the composition comprises pentaerythritol tetrastearate as a demolding agent.

In preferred embodiments the composition comprises as a stabilizer at least one representative selected from the group consisting of sterically hindered phenols, organic phosphites, sulfur-based co-stabilizers and organic or inorganic Brønsted acids.

In particularly preferred embodiments the composition comprises as a stabilizer at least one representative selected from the group consisting of octadecyl 3-(3,5-di-tert-butyl-4-hydroxyphenyl)propionate and tris(2,4-di-tert-butylphenyl)phosphite.

In especially preferred embodiments the composition comprises as a stabilizer a combination of octadecyl 3-(3,5-di-tert-butyl-4-hydroxyphenyl)propionate and tris(2,4-di-tert-butylphenyl)phosphite.

Particularly preferred compositions comprise pentaerythritol tetrastearate as a demolding agent, at least one representative selected from the group consisting of octadecyl 3-(3,5-di-tert-butyl-4-hydroxyphenyl)propionate and tris(2,4-di-tert-butylphenyl)phosphite as a stabilizer and optionally a Brønsted acid and are free from further polymer additives.

Further preferred compositions comprise pentaerythritol tetrastearate as a demolding agent, a combination of octadecyl 3-(3,5-di-tert-butyl-4-hydroxyphenyl)propionate and tris(2,4-di-tert-butylphenyl)phosphite as a stabilizer, optionally a Brønsted acid and are free from further polymer additives.

### Production of the Molding Materials

The thermoplastic molding compounds according to the invention can be produced for example by mixing the respective constituents in known fashion and melt compounding and melt extruding the resulting mixture at temperatures of 220° C. to 360° C., preferably at 250 to 330° C., particularly preferably at 260 to 320° C., in customary aggregates such as internal kneaders, extruders and twin-shaft screw systems.

The mixing of the individual constituents may be effected in known fashion, either successively or simultaneously, either at about 20° C. (room temperature) or at a higher temperature.

In a preferred embodiment production of the compositions according to the invention is effected in a twin-shaft extruder.

### EXAMPLES

### Component A1

Linear polycarbonate based on bisphenol A having a weight-average molecular weight M_{W} of 25 000 g/mol (determined by GPC against a BPA-PC standard) and a relative solution viscosity of 1.255.

### Component A2

Linear polycarbonate based on bisphenol A having a weight-average molecular weight M_{W} of 18 000 g/mol (determined by GPC against a BPA-PC standard) and a relative solution viscosity of 1.20.

### Component A3

Linear polycarbonate based on a mixture of 89 wt % of bisphenol A and 11 wt % of bisphenol TMC (1,1′-bis(4-hydroxyphenyl)-3,3′,5-trimethylcyclohexane) having a weight-average molecular weight M_{W} of 25 000 g/mol (determined by GPC against a BPA-PC standard) and a relative solution viscosity of 1.255.

### Component A4

Linear polycarbonate based on a mixture of 55 wt % of bisphenol A and 45 wt % of bisphenol TMC (1,1′-bis(4-hydroxyphenyl)-3,3′,5-trimethylcyclohexane) having a weight average molecular weight M_{W} of 28 000 g/mol (determined by GPC against a BPA-PC standard) and a relative solution viscosity of 1.255.

### Component A5

Linear polycarbonate based on a mixture of 32 wt % of bisphenol A and 68 wt % of bisphenol TMC (1,1-bis(4-hydroxyphenyl)-3,3′5-trimethylcyclohexane) having a weight-average molecular weight M_{W} of 29 000 g/mol (determined by GPC against a BPA-PC standard) and a relative solution viscosity of 1.255.

### Component A6

Linear polycarbonate based on a mixture of 64 wt % of bisphenol A and 36 wt % of 2-phenyl-3,3′-bis(4-hydroxyphenyl)phthalimide (PPPBP) having a weight-average molecular weight M_{W} of 22 500 g/mol (determined by GPC against a BPA-PC standard) and a relative solution viscosity of 1.215.

### Component B-1

ABS graft polymer based on a polybutadiene rubber as the rubber base having an acrylonitrile:butadiene:styrene ratio of 13:50:37 wt % and having a gel content, measured in acetone, of 80 wt %, produced in emulsion polymerization. The median particle size d₅₀ of the rubber base is 0.4 μm and 30 wt % of the rubber particles used as the graft base for producing this ABS graft polymer have a particle diameter of less than 200 nm, measured by ultracentrifugation in each case.

### Component B-2

ABS graft polymer based on a polybutadiene rubber as the graft base having an acrylonitrile:butadiene:styrene ratio of 11:59:30 wt % and having a gel content, measured in acetone, of 90 wt %, produced in emulsion polymerization. The median particle size d₅₀ of the rubber base is 0.4 μm and 0 wt % of the rubber particles used as the graft base for producing this ABS graft polymer have a particle diameter of less than 200 nm, measured by ultracentrifugation in each case, i.e. all rubber particles are larger than 200 nm.

### Component C-1

SAN copolymer having an acrylonitrile content of 23 wt % and a weight-average molecular weight of 130 000 g/mol (determined by GPC against a polystyrene standard).

### Component D-1

pentaerythritol tetrastearate

### Component D-2

Phosphite stabilizer Irgafos 168 (BASF; Ludwigshafen, Germany)

### Component D-3

Phenolic antioxidant Irganox 1076 (BASF, Ludwigshafen, Germany)

### Component D-4

Calcium dihydrogenphosphate

### Production and Testing of the Molding Materials of the Invention

The mixing of the components was effected in a Coperion, Werner & Pfleiderer ZSK-25 twin-shaft extruder at a melt temperature of 270 to 300° C., a throughput of 20 kg/h and a speed of 220 to 300 rpm. The temperatures of the melt of the compositions measured at the nozzle outlet were 270 to 350° C.—depending on the viscosity of the composition, the melt temperature increasing with increasing viscosity. The molded articles were produced at a melt temperature of 280° C. and a mold temperature of 80° C. on an Arburg 270E injection molding machine. In all cases the injection pressure was not more than 300 bar.

The melt volume flow rates MVR were determined according to ISO 1133 (2012 version) at a temperature of 320° C. and with a ram loading of 1.2 kg.

The melt viscosities were determined according to ISO 11443 (2014 version) at 260/300° C. at a shear rate of 1000 s⁻¹ in both cases.

Galvanizability was evaluated with reference to completeness of metal coverage achieved in a conventional galvanizing process for ABS+PC compositions and the appearance of blister-shaped metal detachments directly after performing the galvanizing process. An evaluation of “i.O” describes a result of visually complete metal coverage on the entire molding surface without any coverage gaps or any blister formation. Galvanizability was tested on sheets having dimensions of 150 mm×100 mm×2 mm which were produced in the injection molding process under the abovementioned conditions.

Galvanizing was effected as follows: The plastics carrier produced by injection molding was initially pickled with chromosulfuric acid (390 g/liter of chromic acid and 390 g/liter of conc. sulfuric acid) for 18 minutes at 68° C. This was followed by rinsing with water. Remaining chromosulfuric acid residues were subsequently reduced with Adhemax® Neutralizer CR for one minute at 35° C., the thus treated molding was again rinsed with water and then treated with Neolink® H (produced by Atotech) as conditioner for 3 minutes at 35° C. The thus pretreated plastic carrier was activated by adsorption of a palladium colloid having a tin chloride sheath (Adhemax® Activator SF, produced by Atotech). Activation was effected at 35° C. and an activation time of 4 min. The concentration of palladium in the aqueous activation solution was 50 mg Pd/liter. The colloid was destroyed by subsequent treatment with Adhemax® accelerator ACC1 (produced by Atotech) for 4 minutes at 40° C., thus forming palladium seeds. This was followed by deposition of chemical nickel from Adhemax® LSF for 9 minutes at 40° C. The component part was subsequently immersed in sulfuric acid for 30 seconds at room temperature. Then, initially a copper metal layer, followed by a nickel metal layer and in turn followed by a chromium metal layer were electrochemically applied.

To determine adhesion of the metal layer to the plastics carrier the abovedescribed process was repeated and aborted after electrochemical application of the copper metal layer.

The thickness of the applied copper metal layer was on average 30 μm.

The adhesion of the metal layer to the plastics carrier was determined in a roller peel test according to DIN 53494 (1989 version). To this end, test specimens having a length of 80 mm and a width (in a departure from the standard) of 10 mm were cut out of the abovedescribed sheets. The pulloff speed was 50 mm/min. The measured pulloff force was normalized over the specimen width (measured values in N/mm) and—neglecting the first and last 10 mm of the pulloff sector—averaged over the entire pulloff sector. The reported measured values are averages from five measurements.

To determine the palladium coverage achieved in the activation step of the galvanizing process the abovedescribed galvanizing process was repeated but aborted after destruction of the palladium colloid. The thus pretreated sheets were treated with a mixture of one part per volume of aqua regia and one part by volume of DM water and in this way the palladium seeds were fully dissolved. After suitable dilution the palladium content of this solution was determined by inductively coupled plasma optical emission spectroscopy (ICP-OES).

The heat resistance of the galvanized molding (sheets having dimensions of 150 mm×100 mm×2 mm) is the maximum temperature (varied in steps of 5° C.) at which after two hours of storage immediately after removal of the component part from the oven and cooling to room temperature no distortion and no detachment of the metal layer (for example in the form of blister formation) was observed.

TABLE 1
Compositions and properties thereof

| | 1 | 2 | 3 | CE4 | CE5 | 6 | 7 | 8 | 9 | 10 | 11 | CE12 | CE13 | CE14 | CE15 | 16 | 17 |
|---|---|---|---|---|---|---|---|---|---|---|---|---|---|---|---|---|---|
| Components | | | | | | | | | | | | | | | | | |
| [parts by weight] | | | | | | | | | | | | | | | | | |
| A-1 | 85 | | | | | | | | | | | | | | | | 80 |
| A-2 | | | | | | | 21.25 | 20 | | | | | | | | | |
| A-3 | | 85 | 42.5 | | | | | | 80 | 70 | 60 | 80 | 80 | 80 | 80 | 80 | |
| A-4 | | | 42.5 | 85 | | | 63.75 | 60 | | | | | | | | | |
| A-5 | | | | | 85 | | | | | | | | | | | | |
| A-6 | | | | | | 85 | | | | | | | | | | | |
| B-1 | 15 | 15 | 15 | 15 | 15 | 15 | 15 | 20 | 20 | 30 | 40 | 15 | 10 | 7 | 4 | | 20 |
| B-2 | | | | | | | | | | | | | | | | 17 | |
| C-1 | | | | | | | | | | | | 5 | 10 | 13 | 16 | 3 | |
| D-1 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 |
| D-2 | 0.02 | 0.02 | 0.02 | 0.02 | 0.02 | 0.02 | 0.02 | 0.02 | 0.02 | 0.02 | 0.02 | 0.02 | 0.02 | 0.02 | 0.02 | 0.02 | 0.02 |
| D-3 | 0.28 | 0.28 | 0.28 | 0.28 | 0.28 | 0.28 | 0.28 | 0.28 | 0.28 | 0.28 | 0.28 | 0.28 | 0.28 | 0.28 | 0.28 | 0.28 | 0.28 |
| D-4 | 0.004 | 0.004 | 0.004 | 0.004 | 0.004 | 0.004 | 0.004 | 0.004 | 0.004 | 0.004 | 0.004 | 0.004 | 0.004 | 0.004 | 0.004 | 0.004 | 0.004 |
| Formulation | | | | | | | | | | | | | | | | | |
| characteristics | | | | | | | | | | | | | | | | | |
| K [wt %] | 7.5 | 7.5 | 7.5 | 7.5 | 7.5 | 7.5 | 7.5 | 10.0 | 10.0 | 15.0 | 20.0 | 7.5 | 5.0 | 3.5 | 2.0 | 10.0 | 10.0 |
| S [wt %] | 3.0 | 3.0 | 3.0 | 3.0 | 3.0 | 3.0 | 3.0 | 4.0 | 4.0 | 6.0 | 8.0 | 8.0 | 12.0 | 14.4 | 16.8 | 4.7 | 4.0 |
| K/S | 2.5 | 2.5 | 2.5 | 2.5 | 2.5 | 2.5 | 2.5 | 2.5 | 2.5 | 2.5 | 2.5 | 0.9 | 0.4 | 0.2 | 0.1 | 2.1 | 2.5 |
| A_{cyc} [wt %] | 0 | 11 | 28 | 45 | 68 | 36 | 34 | 34 | 11 | 11 | 11 | 11 | 11 | 11 | 11 | 11 | 0 |
| Properties | | | | | | | | | | | | | | | | | |
| MVR | 7.6 | 8.6 | 5.5 | 3.6 | 2.1 | 5.0 | 6.5 | 3.8 | 5.7 | 3.9 | 1.9 | 13.6 | 21.7 | 25.8 | 31.0 | 6.7 | 7.8 |
| [ml/10 min] | | | | | | | | | | | | | | | | | |
| Viscosity at | 476 | 597 | | | | | | | 530 | 472 | 439 | 409 | 324 | 294 | 267 | 514 | 448 |
| 260° C. [Pas] | | | | | | | | | | | | | | | | | |
| Viscosity at | | 254 | 323 | 418 | 641 | 375 | 302 | 281 | 237 | | | | | | | | |
| 300° C. [Pas] | | | | | | | | | | | | | | | | | |
| Pd [mg/m²] | n.m. | 5.8 | 5.6 | 5.5 | 4.8 | 6.5 | 4.8 | 6.0 | 8.8 | 16.5 | 25.0 | 7.0 | 6.9 | 5.6 | 5.4 | 12.0 | n.m. |
| Galvanizing | OK | OK | OK | OK | OK | OK | OK | OK | OK | OK | OK | OK | Blisters | Blisters | Blisters | OK | OK |
| Adhesion | n.m. | 0.31 | 0.20 | 0.13 | 0.07 | 0.39 | 0.21 | 0.39 | 0.46 | 0.42 | 0.48 | 0.16 | 0.09 | 0.04 | 0.04 | 0.30 | n.m. |
| [N/mm] | | | | | | | | | | | | | | | | | |
| Heat resistance [° C.] | 130 | 140 | 150 | 155 | 150 | 150 | n.m. | 150 | 140 | 150 | 140 | <115 | n.m. | n.m. | n.m. | 145 | 130 |

n.m.: not measured

n.m.: not measured

The examples show that the inventive component parts according to examples 1-3, 6-11 and 16-17 achieve the object of the invention while the component parts according to comparative examples CE4, CE5 and CE12-CE15 depart in at least one property from the target profile of properties of the object of the invention.

The component parts based on the compositions according to examples 1 and 17 which do not employ any polycarbonate comprising monomer units derived from bis(4-hydroxyphenyl) compounds and bridged via the 1,1′-position of a cyclic hydrocarbon optionally substituted with heteroatoms result in the galvanized component part in a heat resistance which is still just sufficient. However, as is shown by a comparison of examples 1 and 17 with the preferred corresponding inventive examples 2 and 3 and 6-9, it is advantageous in terms of the heat resistance of the galvanized component part to employ as component A a polycarbonate comprising limited amounts of monomer units derived from bis(4-hydroxyphenyl) compounds and bridged via the 1,1′-position of a cyclic hydrocarbon optionally substituted with heteroatoms.

In the component parts according to comparative examples CE4 and CE5 comprising compositions which by contrast employ polycarbonate having an excessively high content of monomer units derived from bis(4-hydroxyphenyl) compounds and bridged via the 1,1′-position of a cyclic hydrocarbon optionally substituted with heteroatoms, inadequate adhesion of the metal layer to the plastics carrier results.

The component parts according to inventive examples 10 and 11 show that when using polycarbonate comprising a minimum amount of monomer units derived from bis(4-hydroxyphenyl) compounds and bridged via the 1,1′-position of a cyclic hydrocarbon optionally substituted with heteroatoms a sufficient heat resistance of the galvanized component part may still be achieved even with polycarbonate contents as low as 60 wt % based on the sum of PC and ABS.

The polycarbonate composition in the component part according to comparative example CE12 employs the same polycarbonate component as the composition employed in the component part according to inventive example 2 and also has the same rubber content. However, compared to the inventive example 2 in which a polycarbonate composition having a lower content of free vinyl copolymer S and thus having a higher ratio of K/S is employed, in the component part according to comparative example CE12 insufficient adhesion of the metal layer to the plastics carrier and an excessively low heat resistance of the component part results. The same also applies to comparative examples CE13 to CE15 having a further reduced ratio K/S, incomplete adhesion of the metal layer to the plastics carrier in the form of blister formation being observed here even before a heat treatment.

A comparison of the preferred inventive examples 8 and 9 compared to the corresponding examples 7 and 2 having a lower rubber content shows that with a further increased rubber content the flowability of the melt and thus the processing behavior improves, the adhesion of the metal layer to the plastics carrier increases and, when comparing examples 8 and 7, even the heat resistance is additionally improved.

A comparison of inventive example 16 with the preferred inventive example 9 of similar composition shows the fundamental advantage of using a rubber-containing graft polymer having a high proportion of small rubber particles in the graft base having regard to the metal-plastic adhesion achieved with particular palladium coverages. This makes it possible to reduce the amount of palladium employed in the galvanizing process and thus reduce process costs. A comparison of inventive example 3 and comparative example CE4 with preferred inventive example 6 of similar composition shows that compared to polycarbonates comprising monomer units derived from 1,1-bis(4-hydroxyphenyl)-3,3′,5-trimethylcyclohexane (bisphenol TMC) using polycarbonates comprising monomer units derived from 2-phenyl-3,3′-bis(4-hydroxyphenyl)phthalimide (PPPBP) makes it possible to realize a further improved metal adhesion at comparable melt flowability and heat resistance of the galvanized component parts.

1.-15. (canceled)

16. A composite component part consisting of a plastics carrier and a multi-ply metal layer applied via a galvanizing process, wherein the plastics carrier is produced from a thermoplastic composition consisting of
A) 50 to 90 parts by weight of at least one aromatic polycarbonate,
B) 10 to 50 parts by weight of at least one graft polymer comprising a diene-containing elastomeric particulate graft base and a vinyl (co)polymer sheath,
C) 0 to 15 parts by weight of at least one additive,
wherein the sum of the parts by weight of components A) and B) in the composition is normalized to 100,
(i) characterized in that the rubber content from component B in the composition is at least 6 wt %,
(ii) characterized in that the ratio K/S of the weight fractions of butadiene-containing elastomeric particulate graft base from component B) in the composition (=K) to the sum of free vinyl (co)polymer from component B) and any free vinyl (co)polymer from component C) in the composition (=S) is at least 1.5,
(iii) characterized in that component A) comprises at least one monomer unit selected from the group consisting of monomer units described by general formula (2) 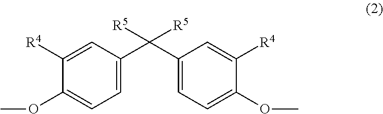
in which
R⁴ represents H, linear or branched C₁-C₁₀ alkyl and
R⁵ represents linear or branched C₁-C₁₀ alkyl,
and such monomer units derived from bis(4-hydroxyphenyl) compounds and bridged via the 1,1′-position of a cyclic hydrocarbon optionally substituted with heteroatoms,
(iv) characterized in that the proportion (A_{cyc}) of monomer units derived from bis(4-hydroxyphenyl) compounds and bridged via the 1,1′-position of a cyclic hydrocarbon optionally substituted with heteroatoms based on the sum of all monomer units derived from bisphenols in component A) is in the range from 0 to 40 wt %,
wherein in the case where the proportion (A_{cyc}) of monomer units derived from bis(4-hydroxyphenyl) compounds and bridged via the 1,1′-position of a cyclic hydrocarbon optionally substituted with heteroatoms based on the sum of all monomer units derived from bisphenols in component A) is in the range <5 wt %, the content of component A) in the composition is 75 to 87 parts by weight and the content of component B) in the composition is 13 to 25 parts by weight.

17. The composite component part as claimed in claim 16 consisting of a plastics carrier and a metal layer applied via a galvanizing process, wherein the plastics carrier is produced from a thermoplastic composition consisting of
A) 60 to 87 parts by weight of at least one aromatic polycarbonate,
B) 13 to 40 parts by weight of at least one graft polymer comprising a diene-containing elastomeric particulate graft base and a vinyl (co)polymer sheath,
C) 0.2 to 3 parts by weight of at least one additive,
wherein the sum of the parts by weight of components A) and B) in the composition is normalized to 100.

18. The composite component part as claimed in claim 16, characterized in that the ratio K/S is at least 2.1.

19. The composite component part as claimed in claim 16, characterized in that A_{cyc} is between 10 and 37 wt %.

20. The composite component part as claimed in claim 16, characterized in that the monomer units derived from bis(4-hydroxyphenyl) compounds and bridged via the 1,1′-position of a cyclic hydrocarbon optionally substituted with heteroatoms are selected from the structures described by the formulae 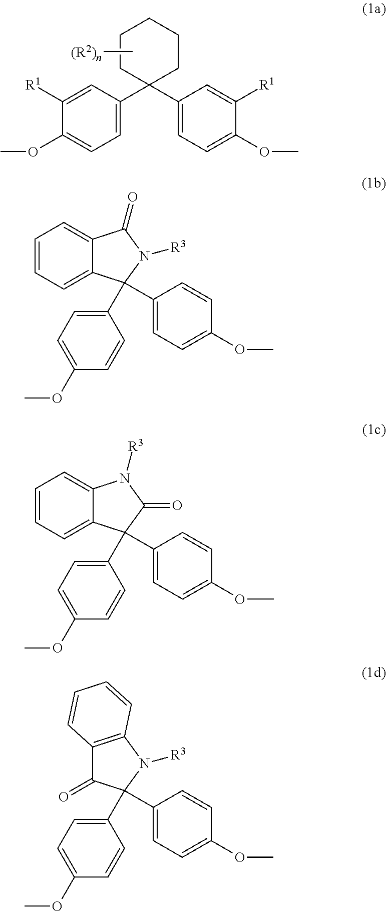
in which
R¹ represents hydrogen or C₁-C₄-alkyl,
R² represents C₁-C₄-alkyl,
n represents 0, 1, 2 or 3 and
R³ represents C₁-C₄-alkyl, aralkyl or aryl.

21. The composite component part as claimed in claim 20, characterized in that the monomer units derived from bis(4-hydroxyphenyl) compounds and bridged via the 1,1′-position of a cyclic hydrocarbon optionally substituted with heteroatoms are selected from the structures described by the formulae (1b), (1c) and (1d).

22. The composite component part as claimed in claim 21, characterized in that the monomer unit derived from bis(4-hydroxyphenyl) compounds and bridged via the 1,1′-position of a cyclic hydrocarbon optionally substituted with heteroatoms is derived from 2-phenyl-3,3′-bis(4-hydroxyphenyl)phthalimide.

23. The composite component part as claimed in claim 16, characterized in that the relative solution viscosity of component A measured in methylene chloride as claimed in DIN 51562 is in the range from 1.20 to 1.28.

24. The composite component part as claimed in claim 16, characterized in that the proportion of rubber particles in the graft base B.2 having a diameter of <200 nm is at least 20 wt %.

25. The composite component part as claimed in claim 16, characterized in that the metal layer surface has a gloss measured as claimed in ISO 2813 at a viewing angle of 60° of greater than 90.

26. The composite component part as claimed in claim 16, characterized in that the multi-ply metal layer consists of at least 3 metal plies distinguishable by microscopy and/or chemical analysis.

27. The composite component part as claimed in claim 16, characterized in that the multi-ply metal layer is constructed, starting from the plastics carrier,
from a first ply of copper, a second ply of nickel and a third ply of chromium or
from a first ply of nickel, a second ply of copper, a third ply of nickel and a fourth ply of chromium.

28. The composite part as claimed in claim 27, characterized in that the nickel metal layer which, starting from the plastics carrier, follows the copper metal layer has a thickness of not more than half of that of the copper metal layer therebelow.

29. The composite component part as claimed in claim 16 characterized in that the multi-ply metal layer has a thickness of 30 to 50 μm.

30. The use of the composite component part as claimed in claim 16 as a part of automobiles, electrically operated devices, household objects, solar collectors, light reflectors or as a functional element for the removal of heat.
